(19) United States
(12) Patent Application Publication
(10) Pub. No.: US 2026/0156432 A1
(43) Pub. Date: Jun. 4, 2026

(54) SOUND VISUALIZATION IN A HEAD-UP DISPLAY FOR A VEHICLE

(71) Applicant: GM GLOBAL TECHNOLOGY OPERATIONS LLC, Detroit, MI (US)

(72) Inventors: Beom Lee, Gyeonggi-do (KR); Seokju Yong, Jr., Bucheon-si (KR); Jeehyung Lee, Seoul (KR); Gaurav Talwar, Novi, MI (US)

(73) Assignee: GM GLOBAL TECHNOLOGY OPERATIONS LLC, Detroit, MI (US)

(21) Appl. No.: 18/967,627

(22) Filed: Dec. 3, 2024

(51) Int. Cl. H04S 7/00

(52) U.S. Cl. CPC H04S 7/40; H04R 2499/13; H04S 2400/11

(57) ABSTRACT

Methods and vehicle with sound visualization are provided. A vehicle includes a graphic projection display; exterior microphones mounted to the vehicle; and a processing device programmed to receive audio signals from the exterior microphones; retrieve map data in a region around the vehicle; identify from the audio signals a sound of interest; identify a location of a source of the sound of interest; determine a stationary status or a moving status of the source; when the source has the moving status, determining a direction and speed of movement of the source; ascertain from the map data and from the location, stationary status, moving status, direction, and/or speed, a preferred driving maneuver; determine a graphic exemplifying the preferred driving maneuver; and display the graphic upon the graphic projection display.

### INTRODUCTION

The technical field generally relates to systems for alerting a driver of a vehicle, such as by providing visual alerts in a head-up display in response to detection of sound.

As the Active Noise Cancelling (ANC) function of vehicles is strengthened, external noise may not be transmitted well to the driver. Additionally, when the driver turns up the interior sound loudly or is distracted, there is a greater risk that exterior sounds may be ignored

Accordingly, it is desirable to detect exterior sounds from outside a vehicle, identify the identity and location of the sound source, and provide notice to the driver regarding the sound source identity and location. Furthermore, other desirable features and characteristics of the present invention will become apparent from the subsequent detailed description and the appended claims, taken in conjunction with the accompanying drawings and the foregoing technical field and background.

### SUMMARY

In an embodiment, a vehicle is provided and includes a graphic projection display; exterior microphones mounted to the vehicle; and a processing device programmed to receive audio signals from the exterior microphones; retrieve map data in a region around the vehicle; identify from the audio signals a sound of interest; identify a location of a source of the sound of interest; determine a stationary status or a moving status of the source; when the source has the moving status, determining a direction and speed of movement of the source; ascertain from the map data and from the location, stationary status, moving status, direction, and/or speed, a preferred driving maneuver; determine a graphic exemplifying the preferred driving maneuver; and display the graphic upon the graphic projection display.

In certain embodiments of the vehicle, the graphic projection display includes a substantially transparent windscreen head-up display including one of light emitting particles and microstructures over a predefined region of the windscreen permitting luminescent display while permitting vision therethrough.

In certain embodiments, the vehicle further includes a haptic device, and the processing device is programmed to activate the haptic device to provide a haptic alert to a user of the source of the sound of interest.

In certain embodiments, the vehicle further includes an audio device, and the processing device is programmed to duck a current audio output from the audio device; and activate the audio device to provide an audio alert to a user of the source of the sound of interest.

In certain embodiments of the vehicle, the audio alert includes a vocalization of instructions of the preferred driving maneuver.

In certain embodiments of the vehicle, the exterior microphones include front exterior microphones mounted at a front of the vehicle and rear exterior microphones mounted at a rear of the vehicle, wherein the processing device is programmed to identify the location of a source of the sound of interest based on a decibel difference between audio signals received from the front exterior microphones and the rear exterior microphones.

In certain embodiments of the vehicle, the interior microphones include a front left interior microphone and a front right interior microphone mounted at a front of the vehicle and a rear left interior microphone and a rear right interior microphone mounted at a rear of the vehicle, wherein the processing device is programmed to identify the location of a source of the sound of interest based on a decibel difference between audio signals received from the front interior microphones and the rear interior microphones.

In certain embodiments, the vehicle further includes interior microphones located inside the vehicle, and the processing device is programmed to receive interior audio signals from the interior microphones.

In another embodiment, a method is provided and includes operating a vehicle; retrieving, with a processor, map data in a region around the vehicle; receiving an audio signal, with the processor, from an exterior microphone mounted at an exterior location of the vehicle; processing, with a processor, the audio signal to determine a location of a source of the audio signal, to optionally determine whether the source is moving, and, if so, to determine a direction and speed of movement of the source; ascertaining from the map data and from the location, direction, and/or speed, a preferred driving maneuver; and actuating an alert device, with the processor, to communicate an alert to a driver of the vehicle regarding the preferred driving maneuver.

In certain embodiments of the method, ascertaining from the map data and from the location, direction, and/or speed, the preferred driving maneuver includes identifying that the location is in an oncoming lane separated from the vehicle by a hard median.

In certain embodiments, the method further includes determining, via the processor, whether the audio signal includes an emergency siren.

In certain embodiments, the method further includes ducking a current audio output, and communicating the alert to the driver includes communicating an audio alert.

In certain embodiments, the method further includes using a large language model to create the audio alert in the form of a vocalized speech.

In certain embodiments of the method, communicating the alert to the driver includes communicating a haptic alert.

In certain embodiments of the method, communicating the alert to the driver includes displaying a visual alert as a graphic exemplifying the preferred driving maneuver.

In another embodiment, a method is provided and includes operating a vehicle along a path; determining, with a processor, that the vehicle is moving up a hill; determining, with the processor, that visual perception of the path is blocked by a crest of the hill; detecting sound from the path blocked by the crest of the hill with a microphone mounted on the vehicle; receiving an audio signal, with the processor, from the microphone; processing, with the processor, the audio signal to determine a location of a source of the audio signal, to determine that the source is moving, and to determine a direction and speed of movement of the source; ascertaining from the map data and from the location, direction, and/or speed, a preferred driving maneuver; and actuating an alert device, with the processor, to communicate an alert to a driver of the vehicle regarding the preferred driving maneuver.

In certain embodiments, the method further includes ducking a current audio output, and communicating the alert to the driver includes communicating an audio alert.

In certain embodiments, the method further includes using a large language model to create the audio alert in the form of a vocalized speech.

In certain embodiments of the method, communicating the alert to the driver includes communicating a haptic alert.

In certain embodiments of the method, communicating the alert to the driver includes displaying a visual alert as a graphic exemplifying the preferred driving maneuver.

### DESCRIPTION OF THE DRAWINGS

The present disclosure will hereinafter be described in conjunction with the following drawing figures, wherein like numerals denote like elements, and wherein:

FIG. 1 is a functional block diagram of a vehicle having a system for determining and communicating an alert in response to auditory stimuli from an environment of the vehicle in accordance with an embodiment;

FIG. 2 is a schematic diagram showing a system architecture of the system of the vehicle of FIG. 1 in accordance with an embodiment;

FIG. 3 is a flow chart illustrating a method for operating the vehicle of FIG. 1 in accordance with an embodiment;

FIG. 4 is a flow chart illustrating a method for operating the vehicle of FIG. 1 in accordance with an embodiment; and

FIG. 5 is a flow chart illustrating a method for operating the vehicle of FIG. 1 in accordance with an embodiment.

### DETAILED DESCRIPTION

The following detailed description is merely exemplary in nature and is not intended to limit the disclosure or the application and uses thereof. Furthermore, there is no intention to be bound by any theory presented in the preceding introduction or summary or the following detailed description.

As used herein, the term module refers to any hardware, software, firmware, electronic control component, processing logic, and/or processor device, individually or in any combination, including without limitation: application specific integrated circuit (ASIC), an electronic circuit, a processor (shared, dedicated, or group) and memory that executes one or more software or firmware programs, a combinational logic circuit, and/or other suitable components that provide the described functionality.

Embodiments of the present disclosure may be described herein in terms of functional and/or logical block components and various processing steps. It should be appreciated that such block components may be realized by any number of hardware, software, and/or firmware components configured to perform the specified functions. For example, an embodiment of the present disclosure may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments of the present disclosure may be practiced in conjunction with any number of systems, and that the systems described herein is merely exemplary embodiments of the present disclosure.

For the sake of brevity, conventional techniques related to signal processing, data transmission, signaling, control, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment of the present disclosure.

In accordance with one or more exemplary embodiments, methods and systems are provided for monitoring an environment around a vehicle (or other machine, device or system for which threat or object detection is desirable), detecting potential threats and presenting contextual notifications to a user (e.g., driver or passenger) of the vehicle. An embodiment of a system is configured to acquire detection data from one or more vehicle sensors, and data relating to vehicle dynamics (e.g., speed, direction), and identify one or more potential threats represented by detected objects. The system acquires or determines a predicted trajectory of a detected object, and generates a notification to the user that accounts for user attentiveness and threat level to provide the user information about predictive dynamics of a threat (or combined threat), provide relevant context, and direct the user's attention. As discussed further below, the notification is customized based on threat level and attentiveness to provide a level of detail and sufficient stimulus to the user, to ensure that the user is alerted to a threat and has sufficient context to react.

The system, in one embodiment, acquires data related to environmental data indicative of the vehicle environment and driving context (e.g., road layout, weather, traffic, etc.). Based on the above information, the system determines a mitigation strategy or route instruction and generates a notification using one or more available modalities that is contextualized based on the threat level.

The notification utilizes one or more of various modalities, including a visual modality (graphics, text, etc.) such as on a head-up display, an auditory modality (e.g., a beep, tone, series thereof, or vocalization of instructions) and a haptic modality (e.g., steering wheel and/or seat vibration). The haptic and auditory modalities may be configured as directional signals to prompt the user to direct attention to a location of a threat. The combination and/or features of each modality are used to generate a notification that enhances user awareness of a given context without overly distracting the user.

Embodiments described herein present a number of advantages. The system provides benefits including enhanced situational awareness, both in providing relevant information to the user in an intuitive manner and effectively and promptly conveying the seriousness of a detected threat and avoidance instructions. The system thus improves user response time and enhances accident avoidance, as compared to conventional systems.

Embodiments herein recognize that as the Active Noise Cancelling (ANC) function of vehicles is strengthened, external noise may not be transmitted well to the driver. Additionally, when the driver turns up the interior sound loudly or is distracted, there is a risk of an accident occurring. Embodiments herein provide a system that uses exterior-mounted microphones or other acoustic sensors to detect noise around the front and rear of the vehicle can be detected. Further, embodiments may confirm the left or right positioning of the source of the noise based on left and right interior-mounted microphones located within the vehicle. The array of microphones may allow detection of important noises, such as human conversation or car horns, and recognize that there are people or vehicles nearby. Further, embodiments herein may display information visually on the head-up display (HUD) to inform the driver of nature of the sound and the exact location of the source of the sound. Haptic alerts may be used to notify the driver of which side the sound is coming from.

Also, embodiments herein may identify a sound as an emergency alert, such as a siren from an ambulance, fire truck, or police vehicle. Using map coordinates of the area around the vehicle, the system processor may identify a most desirable route to avoid the sound source or may identify a safe route passing the sound source. Instructions regarding the most desirable or safest route may be displayed on the head-up-display and/or communication with a vocalization from vehicle speakers.

Embodiments herein may prevent accidents in advance by determining the type and location of sounds occurring around the vehicle and visually warning the device of them through a head-up display that is easy for the driver to recognize.

Embodiments herein may detect noise around the front and rear of the vehicle through a microphone mounted outside the vehicle, determine the decibel difference between the front and rear microphones, and determine the exact location of the noise. Embodiments herein may detect the frequency band of the noise detected by the exterior microphone, recognize the same frequency band through the microphones mounted on the left and right sides of the vehicle interior, and determine the left and right direction of the sound by comparing the decibel difference detected by the left and right microphones. Then, the type of sound and location of sound may be determined, and a warning may be indicated through the Head-Up Display with alert sound. Further notification may use directional haptic alerts (to seat and/or steering wheel) and through auditory outputs. Text-to-speech based feedback using a large language model may be used to generate a vocalization prompt through the speakers, such as providing navigational instructions to avoid or pass the sound source safely.

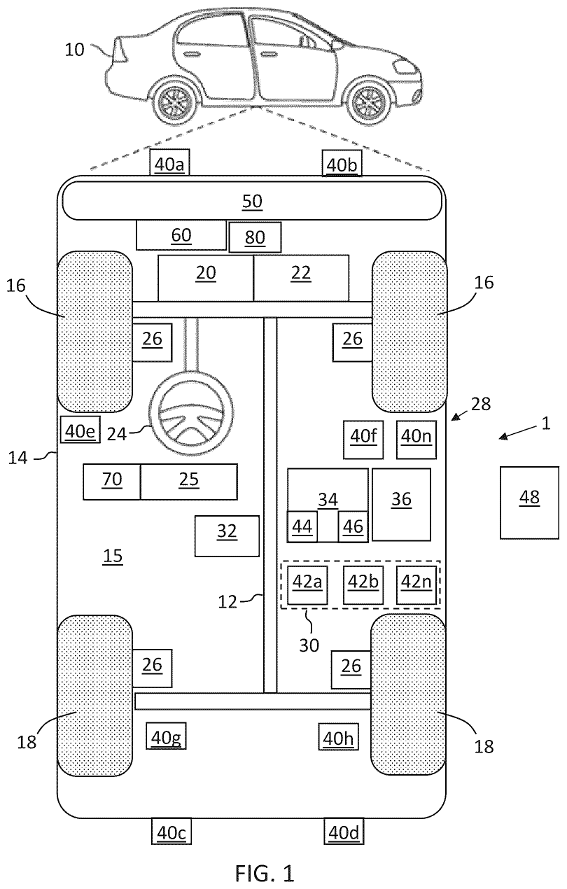

With reference to FIG. 1, a vehicle 10 is shown in accordance with various embodiments. The vehicle 10 generally includes a chassis 12, a body 14 enclosing a vehicle cabin 15, front wheels 16, and rear wheels 18. The body 14 is arranged on the chassis 12 and substantially encloses components of the vehicle 10. The body 14 and the chassis 12 may jointly form a frame. The wheels 16 and 18 are each rotationally coupled to the chassis 12 near a respective corner of the body 14.

In various embodiments, the vehicle 10 is operated by a driver, i.e., not an autonomous vehicle that is automatically controlled to carry passengers from one location to another. The vehicle 10 is depicted in the illustrated embodiment as a passenger car, but it should be appreciated that any other vehicle including motorcycles, trucks, sport utility vehicles (SUVs), recreational vehicles (RVs), marine vessels, aircraft, etc., may also be used.

As shown in FIG. 1, the vehicle 10 generally includes a propulsion system 20, a transmission system 22, a steering system 24, a brake system 26, a sensor system 28, an actuator system 30, at least one data storage device 32, at least one controller 34, and a communication system 36. The propulsion system 20 may, in various embodiments, include an internal combustion engine, an electric machine such as a traction motor, and/or a fuel cell propulsion system. The transmission system 22 is configured to transmit power from the propulsion system 20 to the vehicle wheels 16 an 18 according to selectable speed ratios. According to various embodiments, the transmission system 22 may include a step-ratio automatic transmission, a continuously-variable transmission, or other appropriate transmission. The brake system 26 is configured to provide braking torque to the vehicle wheels 16 and 18. The brake system 26 may, in various embodiments, include friction brakes, brake by wire, a regenerative braking system such as an electric machine, and/or other appropriate braking systems. The steering system 24 influences a position of the of the vehicle wheels 16 and 18. While depicted as including a steering wheel for illustrative purposes, in some embodiments contemplated within the scope of the present disclosure, the steering system 24 may not include a steering wheel. As shown, the steering wheel 24 is located within reach of a driver's seat 25 in cabin 15.

As shown in FIG. 1, the vehicle 10 includes a front windscreen 50 that encloses the cabin 15. Further, the vehicle includes a head-up display 60 configured to project light upon the windscreen 50 where the light is converted into a viewable display. The head-up display 60 is configured to present information to the operator of the vehicle 10 in an effective manner by reducing strain upon the operator by allowing the operator to reduce unnecessary eye scan and glance behavior to remain focused on driving and visual tracking.

As shown in FIG. 1, the vehicle 10 includes a haptic feedback system 70. The haptic feedback system 70 is configured to provide an alert or other communication through the sense of touch by vibrations, motion, or other forces. As illustrated the haptic feedback device 70 may provide a haptic signal through the driver's seat 25. Additionally or alternatively, the haptic feedback device 70 may provide a haptic signal through the steering wheel 24, through pedals (not illustrated), through the floor of the cabin 15, or in a different manner.

As shown in FIG. 1, the vehicle 10 includes an audio/visual input/output system 80. For example, the audio/visual input/output system 80 may include an input/output touch screen for receiving input from a user and for visually displaying information and/or graphics. Further, the audio/visual input/output system 80 may include speakers for communicating information and/or for emitting alerts, warnings, or other audio signals, and for playing music or entertainment programs.

As shown in FIG. 1, the sensor system 28 includes one or more sensing devices 40a-40n that sense observable conditions of the exterior environment and/or the interior environment of the vehicle 10. The sensing devices 40a-40n may include, but are not limited to, radars, Lidars (light detection and ranging), acoustic sensors, global positioning systems, optical cameras, thermal cameras, ultrasonic sensors, and/or other sensors. For example, the sensing devices 40 may include an acoustic sensor, like a microphone, etc. In the embodiment of FIG. 1, the vehicle includes a front left exterior acoustic sensor or microphone 40a, a front right exterior acoustic sensor or microphone 40b, a rear left exterior acoustic sensor or microphone 40c, a rear right exterior acoustic sensor or microphone 40d, a front left interior acoustic sensor or microphone 40e, a front right interior acoustic sensor or microphone 40f, a rear left interior acoustic sensor or microphone 40g, and a rear right interior acoustic sensor or microphone 40h. Other arrangements with more or fewer microphones are contemplated. In certain embodiments, the exterior microphones are mounted to an external surface of the vehicle 10, while the interior microphones are mounted within the cabin 15 of the vehicle 10 or at other interior locations.

The actuator system 30 includes one or more actuator devices 42a-42n that may control one or more vehicle features such as, but not limited to, the propulsion system 20, the transmission system 22, the steering system 24, the brake system 26, the head-up display 60, the haptic feedback system 70, or the audio/visual system 80.

In various embodiments, the vehicle features may further include interior and/or exterior vehicle features such as, but are not limited to, doors, a trunk, and cabin features such as air, lighting, etc. (not numbered).

In the embodiment of FIG. 1, the communication system 36 is configured to wirelessly communicate information to and from other entities 48, such as but not limited to, other vehicles (“V2V” communication,) infrastructure (“V2I” communication), remote systems, and/or personal devices. In an exemplary embodiment, the communication system 36 is a wireless communication system configured to communicate via a wireless local area network (WLAN) using IEEE 802.11 standards or by using cellular data communication. However, additional or alternate communication methods, such as a dedicated short-range communications (DSRC) channel, are also considered within the scope of the present disclosure. DSRC channels refer to one-way or two-way short-range to medium-range wireless communication channels specifically designed for automotive use and a corresponding set of protocols and standards.

In the embodiment of FIG. 1, the data storage device 32 stores data for use in facilitating operation of the vehicle 10 and/or for automatically controlling certain aspects of operation of the vehicle 10. In various embodiments, the data storage device 32 stores defined maps of the navigable environment. In various embodiments, the defined maps may be predefined by and obtained from a remote system. For example, the defined maps may be assembled by the remote system and communicated to the vehicle 10 (wirelessly and/or in a wired manner) and stored in the data storage device 32. As may be appreciated, the data storage device 32 may be part of the controller 34, separate from the controller 34, or part of the controller 34 and part of a separate system.

As shown in FIG. 1, the controller 34 includes at least one processor 44 and a computer readable storage device or media 46. The computer readable storage media 46 and/or the storage device 32 may store a pre-programmed driving maneuver of the vehicle 10, wherein the pre-programmed driving maneuver may be indicative of an upcoming driving path of the vehicle 10. The processor 44 may be any custom made or commercially available processor, a central processing unit (CPU), a graphics processing unit (GPU), an auxiliary processor among several processors associated with the controller 34, a semiconductor based microprocessor (in the form of a microchip or chip set), a macroprocessor, any combination thereof, or generally any device for executing instructions. The computer readable storage device or media 46 may include volatile and nonvolatile storage in read-only memory (ROM), random-access memory (RAM), and keep-alive memory (KAM), for example. KAM is a persistent or non-volatile memory that may be used to store various operating variables while the processor 44 is powered down. The computer-readable storage device or media 46 may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 34 in controlling operations of the vehicle 10.

In the embodiment of FIG. 1, the instructions may include one or more separate programs, each of which includes an ordered listing of executable instructions for implementing logical functions. The instructions, when executed by the processor 44, receive and process signals from the sensor system 28, perform logic, calculations, methods and/or algorithms for automatically controlling the components of the vehicle 10, and generate control signals to the actuator system 30 to automatically control certain components of the vehicle 10 based on the logic, calculations, methods, and/or algorithms. Although only one controller 34 is shown in FIG. 1, embodiments of the vehicle 10 may include any number of controllers 34 that communicate over any suitable communication medium or a combination of communication mediums and that cooperate to process the sensor signals, perform logic, calculations, methods, and/or algorithms, and generate control signals to automatically control certain features of the vehicle 10.

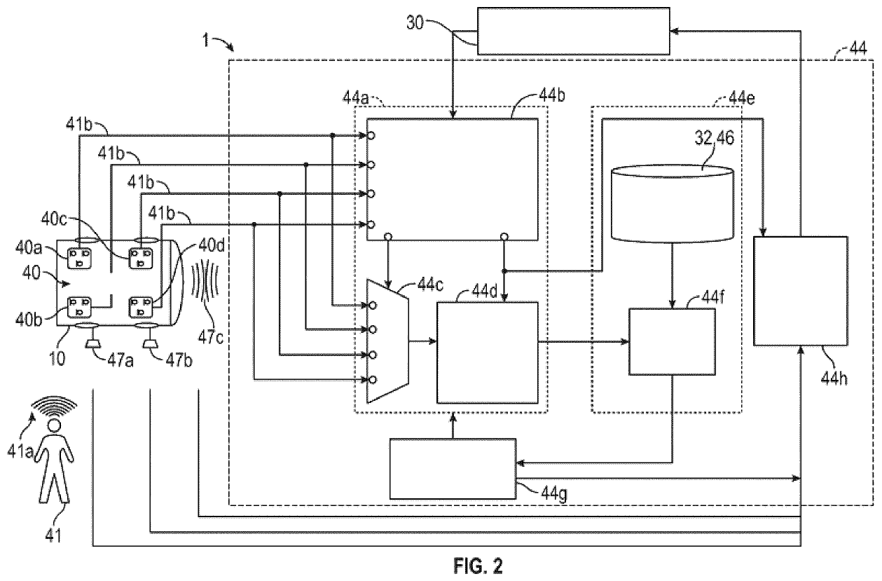

In various embodiments of FIG. 1, one or more instructions of the controller 34 are embodied. The controller includes the non-transitory computer readable medium 46 that stores a pre-programmed driving maneuver of the vehicle 10, which is indicative of a driving path of the vehicle 10 and, in particular indicates a driving path along which the vehicle 10 will travel. The controller also includes the processor 44 which is configured to obtain audio data of at least one acoustic source 41 in the environment of the vehicle 10. The acoustic source 41 may be any source emitting an acoustic wave or sound wave travelling, for example, through the air from the acoustic source 41 to the vehicle 10. The controller 34, in particular the functionality of the processor 44, will be described in more detail with reference to FIG. 2.

FIG. 2 is a schematic diagram showing the system architecture of the system 1 for adapting a driving condition of the vehicle 10 shown in FIG. 1. The system 1 may be integrated into the vehicle 10. The vehicle 10 includes an audio sensor arrangement 40 including audio sensor arrays 40a-40d for sensing an acoustic signal 41a, for example a sound wave or acoustic wave, from an acoustic source 41 in the environment of the vehicle 10. Each of the acoustic sensor arrays 40a-40d is arranged at a distinct location at, on or within the vehicle 10. Each of the audio sensor arrays 40a-40d may include one or more audio sensors, for example microphones. In the example shown in FIG. 2, the acoustic source 41 is a child shouting or producing a noise in the environment. The audio sensor arrays 40a-40d receive the acoustic signal 41a from the person and generate acoustic signal data 41b which are provided to the processor 44. It is noted that the processor 44 as well as the system module 30 are depicted separate to the vehicle 10 for reasons of clarity, however it is to be understood that the processor 44 and also the system module 30 of an exemplary embodiment, are parts of the vehicle 10 or integrated into the vehicle 10.

In the exemplary embodiment of FIG. 2, the processor 44 includes an array processing module 44a configured to obtain audio data of the acoustic source 41 based on the acoustic signal data 41b from the audio sensor arrays 40a-40n. While FIG. 2 illustrates audio sensor arrays 40a-40d, any number of audio sensor arrays 40 providing for triangulation may be used. Based on these audio data, the processor 44 determines a receiving direction of the acoustic source 41, wherein the receiving direction is indicative of a direction of the at least one acoustic source 41 relative to the vehicle 10. The receiving direction may, for example, be measured with reference to a longitudinal axis of the vehicle 10. The receiving direction therefore indicates the location of the acoustic source 41 relative to the vehicle 10, for example using three-dimensional coordinates. In particular, two receiving directions may indicate the location of the acoustic source 41. Therefore, at least two audio sensor arrays 40a-40d may be used to determine receiving directions of the acoustic source 41 for each of the at least two audio sensors arrays 40a-40d in order to determine the location of the acoustic source 41. Three-dimensional coordinates may be used to determine the location of the acoustic source 41, wherein it may be possible to ignore acoustic sources 41 that are located above the road, wherein acoustic sources 41 that lie on the road may be further considered. In an exemplary embodiment, all audio sensor arrays 40a-40d are used to determine, i.e., localize the acoustic source 41. This means that each audio sensor array 40a-40d determines one receiving direction for the acoustic source 41 so that, for each audio sensor array 40a-40d, one respective receiving direction of the acoustic source 41 is obtained. These receiving directions are then used to localize the acoustic source 41 and to estimate whether it is located in the driving path or not, i.e., to estimate whether it may be excluded that the acoustic source is located within the driving path or not. The localization is carried out by the localization module 44b of the processor 44. The localization may also use information from an inter-array energy difference which is calculated based on the intensity of the audio signals 41a received by each of the audio sensor arrays 40a-40d. In this manner, a receiving direction of the acoustic source 41 relative to the vehicle 10 may be determined and therefore the acoustic source 41 may be localized such that a location of the acoustic source 41 relative to the vehicle 10 may be determined, for example using three-dimensional coordinates. However, it might be preferred that the localization is determined based on two receiving directions. Energy differences may additionally be used to eliminate hypothetical directions. The described process may be referred to as a low latency, short-range maneuver dependent localization of acoustic sources 41.

In an exemplary embodiment of FIG. 2, the localization of the acoustic sources 41 may be carried out based on an inter-array energy level difference elimination by the localization module 44b of processor 44. This inter-array energy level difference elimination may include a localization based on an acoustic intensity or energy determination of the considered acoustic sources 41, i.e., finding the acoustic source 41 from which the strongest acoustic signal 41a is received by the different audio sensor arrays 40a-40d.

Cross-referencing FIGS. 1 and 2, the processor 44 estimates whether the acoustic source 41 lies within the driving path (not shown) of the vehicle 10 based the determined receiving direction of the acoustic source 41, and based on the location, direction, and speed of the vehicle 10 and based on map coordinates, or based on the pre-programmed driving maneuver or an updated driving maneuver. In certain embodiments, the acoustic source 41 lies within the driving path if the acoustic source 41 is localized such that a collision event between the vehicle 10 and the acoustic source 41 would occur if the acoustic source 41 does not move away and the vehicle 10 continues without driver intervention. In such an event, i.e., when it was estimated that the acoustic source 41 is within or intersects the driving path of the vehicle 10 and therefore the processor 44 estimates that the acoustic source 41 lies within the driving path of the vehicle 10, the processor 44 further determines a range between the vehicle 10 and the acoustic source 41 in order to confirm that the acoustic source 41 certainly lies within the driving path of the vehicle 10. In certain embodiments, the processor 44 may determine the range between the vehicle 10 and the acoustic source 41 if it is determined that the acoustic source 41 lies within the driving path of the vehicle 10. The range determination may thus be used to provide a confirmation whether the acoustic source 41 really lies within the driving path of the vehicle 10, wherein the receiving directions determined beforehand may only indicate which acoustic sources 41 are certainly not within the driving path of the vehicle 10. Therefore, it is possible to consider only those acoustic sources 41 in the range determination which are not excluded to lie within the driving path after the localization using the receiving directions.

In an exemplary embodiment of FIG. 2, it is possible that the localization which is based on the determined receiving directions provides an information about whether the acoustic source 41 may be excluded to lie within the driving path of the vehicle 10 or whether the acoustic source 41 cannot be excluded to lie within the driving path of the vehicle 10. This means that a first estimation is carried out when there is a chance that the acoustic source 41 lies within the driving path. If so, the range between the vehicle 10 and the acoustic source 41 is determined to certainly determine that the acoustic source 41 lies within the driving path or not. If the receiving directions for the acoustic source 41 do not indicate that the acoustic source 41 lies within the driving path, then there is no range determination carried out by the processor 44, i.e., some receiving directions may indicate that the acoustic source 41 is definitely not in the maneuver path and these are not further considered. Therefore, it may be possible that it may only be certainly determined if the source is in the driving path after the range has been determined.

In an exemplary embodiment of FIG. 2, the processor 44 determines the range between the vehicle 10 and the at least one acoustic source 41 based on triangulation using at least two of the audio sensor arrays 40a-40n. In this manner, the range, e.g. the distance between the vehicle 10 and the acoustic source 41 may be determined at a certain point in time.

In an exemplary embodiment of FIG. 2, the processor 44 may also obtain audio data of a plurality of different acoustic sources 41 in the environment of the vehicle 10 and determine a receiving direction for each of the plurality of acoustic sources 41 based on the audio data. In particular, the processor 44 determines the location of each acoustic source 41. The receiving directions are thus indicative of respective directions of the plurality of acoustic sources 41 relative to the vehicle 10 which provides the locations of each of the acoustic sources 41. The processor 44 then determines for each of the acoustic sources 41 whether it lies within the driving path of the vehicle 10 based on the pre-programmed driving maneuver and the determined receiving directions, i.e., locations, of each of the plurality of acoustic sources 41. The processor 44 selects those acoustic sources 41 that are determined to lie within the driving path of the vehicle 10 such that the processor 44 may then determine a range between the vehicle 10 and each of the selected acoustic sources 41. In particular, a range or distance between each acoustic source 41 that lies on the upcoming driving path (selected acoustic sources 41) and the vehicle 10 is determined. The other acoustic sources 41 that are not selected and thus do not lie within the driving path of the vehicle 10 are discarded. In other words, the processor 44 therefore selects all acoustic peaks in the maneuver direction, i.e., all acoustic sources 41 that lie within the driving path of the vehicle 10, and discards all other peaks, i.e., all acoustic sources 41 that do not lie within the driving path of the vehicle 10.

In an exemplary embodiment of FIG. 2, the processor 44 determines a minimum range out of the determined ranges between the selected acoustic sources 41 and the vehicle 10. In other words, only the selected acoustic sources 41 which were determined to lie within the driving path of the vehicle 10 and for which a range has therefore been determined are compared according to their ranges such that a single acoustic source 41 from the plurality of acoustic sources 41, which is most proximal to the vehicle 10, is selected.

In an exemplary embodiment of FIG. 2, the processor 44, for example the array selection module 44c of the processor 44, selects a single one of the audio sensor arrays 40a-40d, for example array 40c. The selection takes place by determining which of the audio sensor arrays 40a-40d receives a maximum signal-to-noise-ratio from the selected single acoustic source 41 which has been selected as being most proximal to the vehicle 10. In other words, the audio sensor array 40c which receives the highest acoustic signal and the lowest acoustic noise may be selected. The result is that a selected single audio sensor array 40c is further used by the processor 44 to beamform towards the selected acoustic source 41 which is most proximal to the vehicle 10, i.e., to select an audio channel for an audio signal from an audio sensor, e.g. from a single audio sensor, of the selected audio sensor array 40c. This may be carried out by the spatial object separation module 44d of the processor 44.

In an exemplary embodiment of FIG. 2, a non-transitory computer readable medium 46 stores pre-trained audio models besides the pre-programmed driving maneuver. The audio models may be descriptive for different acoustic scenarios or the characteristics of different types or arrangements of acoustic sources. The processor 44, in particular the pattern recognition module 44e, is then able to allocate the selected audio signal to at least one of the pre-trained audio models stored on the non-transitory computer readable medium 46. This may be understood as a comparison between the selected audio signal and a pre-trained audio model which is carried out to obtain a certain probability based on which it may be assumed that the selected audio signal belongs to a specific pre-trained audio model. In other words, the selected audio signal is classified. This procedure may be carried out by the type and urgency classifier module 44f of the pattern recognition module 44e. Therefore, a predetermined probability threshold may be applied indicating which probability has to be achieved to indicate that the driving scenario, in particular the acoustic source 41, has been correctly identified. The processor 44 may then determine a type of the at least one acoustic source 41 based on the comparison and the probability calculation. The processor 44 may then also determine an urgency estimation of a current driving scenario by analyzing the driving situation involving the vehicle 10 and the surrounding acoustic sources 41, based on the comparison and the probability calculation. A positive urgency estimation may indicate an upcoming collision event between the acoustic source 41 and the vehicle 10. The urgency estimation may thus be dependent on how urgent an intervention of the vehicle control system is required to avoid a collision event. This may be determined based on a comparison of the selected audio data and the audio models which provides an indication of a probability for a certain current driving scenario, in particular of a current situation describing the positioning and movement of the vehicle 10 and the acoustic source 41. Based on this probability approach, it may be determined how urgent a change of the situation is to be initiated to avoid an upcoming dangerous situation or even a collision between the acoustic source 41 and the vehicle 10. Both the non-transitory computer readable medium 46 and the type and urgency classifier module 44f are parts of the pattern recognition module 44e of processor 44. The urgency estimation may involve an urgency related processing of the audio data based on a pitch variation under doppler impact.

In an exemplary embodiment of FIG. 2, the above described process is iteratively repeated by the processor 44 until a clear, i.e., determinable type and/or urgency estimation is possible. A determinable urgency estimation is present if a positive urgency estimation or a negative urgency estimation may be made. A positive urgency estimation may indicate a likely upcoming collision event between the acoustic source 41 and the vehicle 10 and that further verification of this urgency estimation may be required to provide a control intervention for the vehicle 10. A negative urgency estimation may indicate that a collision event may be excluded. The processor 44 will obtain second audio data of the at least one acoustic source 41 if the result of the urgency estimation is indeterminable or unclear, for example when a classification of the same selected audio signal or another selected audio signal is necessary to carry out the urgency decision, i.e., to make a positive or negative urgency estimation. The decision whether an urgency estimation is positive, negative or indeterminable may be carried out by the urgency decision module 44g. If the result of the urgency estimation is indeterminable, another acoustic sensing of the environment may be carried out to receive further audio signals and to obtain a corresponding second audio signal of another driving scenario based on the obtained second audio data of the at least one acoustic source 41 and the set of audio models.

In certain embodiments of FIG. 2, the processor 44 obtains further sensor data of the at least one acoustic source 41 in the environment of the vehicle 10. These further sensor data may be optical data from a camera 47a or Lidar sensor 47b or data from a radar sensor 47c. The processor 44 has a sensor data fusion module 44h which provides fused data based on a fusion of the further sensor data of the at least one acoustic source 41 with the selected audio data of the at least one acoustic source 41, in particular the selected audio signal from the selected audio channel. The data fusion may provide a verification of the correctness of the urgency estimation which is based on the audio data obtained from the audio sensors, i.e., the audio sensor array arrangement 40. The processor 44 thus verifies the urgency estimation of the current driving scenario based on the fused data. If the urgency estimation is confirmed by the further sensor data and the data fusion, then the processor 44 controls the vehicle 10 based on the verified urgency estimation of the current driving scenario.

In an exemplary embodiment of FIG. 2, the system 1 provides for a low latency classification including a successive evaluation of putative events based on a sensor array detection of a direction of acoustic sources 41 relative to the vehicle 10, a maneuver of the vehicle, a range between the acoustic sources 41 and the vehicle 10 and an urgency estimation being indicative of a requirement to change a driving condition of the vehicle 10. The duration of the evaluation may be incremented and iteratively carried out until a predetermined detection confidence is reached.

In an exemplary embodiment of FIG. 2, the system 1 also provides a maneuver dependent spatial scan. Therein, events may be incrementally evaluated only in the maneuver direction, i.e., only for the acoustic sources 41 which are located in the driving path of the vehicle 10. Afterwards, a range estimation only for acoustic sources located in the maneuver direction is carried out. Furthermore, the beamforming is applied only if the acoustic sources 41 and the range are determined to be in maneuver direction.

In an exemplary embodiment of FIG. 2, the system 1 also provides an architecture for detecting a short range event. A distributed microphone architecture is provided. Some events may be filtered by energy differences between the audio sensor arrays 40a-40d of the audio sensor arrangement 40, wherein the energy differences are based on the different intensities of different acoustic signals 41a received from the acoustic sources 41. By applying this, it is possible exploit the vehicle as a blocking element for the elimination of certain acoustic sources 41 which are therefore not considered for the urgency estimation.

The processor 44 is configured to distinguish emergency audio signals, such as from ambulances, fire trucks, or police. Cross-referencing FIGS. 1 and 2, the processor 44 may further determine whether the acoustic source 41, i.e., emergency audio signal, is located at a protected location relative to the vehicle. For example, by cross-referencing map coordinates, and the location, speed, and direction of movement of the acoustic source 41, the processor may determine what roadway the acoustic source 41 is on, and whether that roadway is separated from the vehicle 10. For example, the processor 44 may determine that the acoustic source 41 is on a different highway from vehicle 10 altogether, such as on an overpass not directly connected to the location of the vehicle 10. Or, the processor 44 may determine that the acoustic source 41 is on the same roadway as the vehicle 10, but that the acoustic source 41 is in the oncoming traffic lanes and that the roadway is a divided highway including a physical barrier between the acoustic source 41 and the vehicle 10. Likewise, the processor 44 may determine that the vehicle 10 is on a surface street and the acoustic source is on a protected highway traveling through the surface streets.

In such scenarios, the direction and speed of travel of the vehicle 10 need not change despite receiving emergency audio signals. The processor 44 may cause the head-up display 60 and/or audio visual system 80 to communicate to the vehicle operator that no change in vehicle operation is needed. For example, the processor 40 may communicate that the emergency audio signal is being received from a source 41 that is not on the roadway in the direction of travel, i.e., the driving path of the vehicle 10.

Alternatively, the processor 44 may determine that the acoustic source 41, i.e., emergency audio signal, is at a more pertinent location relative to vehicle 10, such as located on the roadway ahead of the vehicle 10 in the direction of travel, i.e., on the driving path of the vehicle 10. In such a scenario, the processor 44 may determine a vehicle maneuver to best avoid or safely travel around the emergency acoustic source 41. For example, the processor 44 may refer to map coordinates and generate travel instructions to avoid traveling past the emergency acoustic source 41. Or, the processor 44 may refer to map coordinates and generate travel instructions to slow down and move to an opposite side of the roadway to safely pass the emergency acoustic source 41.

The processor 44 may cause such travel instructions to be displayed on the head-up display 60 and/or audio/visual system 80. Additionally or alternatively, the processor 44 may cause such travel instructions to be vocalized and communicated over the speakers of the audio/visual system 80.

It is noted that the processor 44 may duck current audio output of the audio/visual system 80, i.e., lower the volume of the radio, in response to receiving an emergency audio signal. In other embodiments, the processor 44 may duck current audio output of the audio/visual system 80 when communicating travel instructions to the operator of the vehicle 10.

In certain embodiments, the processor 44 may indicate on which side of the vehicle 10 the emergency acoustic source 41 is located. For example, an alert symbol may be displayed on one side of the head-up display 60, and/or the processor 44 may actuate the haptic feedback system 70 to provide a haptic alert on only one side of the operator's seat 25 to indicate on which side of the vehicle 10 the emergency acoustic source 41.

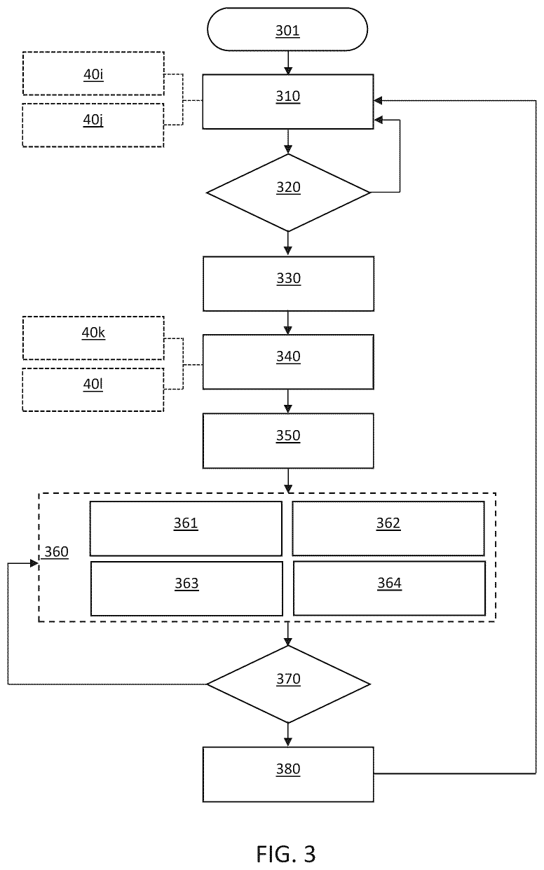

FIG. 3 is a flow chart illustrating a method 300 for operating the vehicle 10. The method is carried out by processor 44 of the system 1 of FIGS. 1 and 2.

As shown in FIG. 3, the method 300 begins with the vehicle propulsion system being actuated “ON” at action block 301. Method 300 includes, at action block 310, monitoring sound outside the vehicle 10, such as with audio sensor arrays 40a-40n. For example, the array of sensors may include an exterior microphone 40i in the engine room of the vehicle, i.e., in the front end of the vehicle 10, and an exterior microphone 40j on the rear end of the vehicle 10.

At inquiry block 320, the method 300 determines, via processor 44, whether the array of sensors detects a sound. When the processor determines that no sound is detected, then method 300 continues monitoring at action block 310. When the processor determines that a sound is detected, then method 300 continues at action block 330 with defining the sound source and determining the front or rear direction, via the processor 44, i.e., whether the source of the sound is located in front of or to the rear of the vehicle 10. For example, a decibel difference between the front and rear sensor arrays may be used to determine the front or rear direction of the source of the sound.

Method 300 then continues at action block 340 with monitoring sound inside the vehicle 10, such as with audio sensor arrays 40a-40n, at the same frequency of the sound defined at action block 330. For example, the array of sensors may include an interior microphone 40k on the left side of the vehicle interior, and an interior microphone 40l on the rear end of the vehicle 10.

At inquiry block 350, the method 300 determines the left or right direction, via the processor 44, i.e., whether the source of the sound is located to the right or to the left of the vehicle 10. For example, a decibel difference between the left and right sensor arrays may be used to determine the left or right direction of the source of the sound.

With the location of the source of the sound identified, the method 300 may continue at action block 360. For example, at action block 361, method 300 may include communicating, via the processor 44, an alert lamp or graphic on the head-up display 60. For example, the alert lamp or graphic may be located on the left or right side of the head-up display 60 corresponding to the left or right side determined at action block 350.

Also, action block 360 may include, at action block 362, ducking the vehicle audio via processor 44, i.e., lowering the volume of the current audio output such as from speakers within the vehicle, and, at action block 363, providing navigational or safety instructions to the driver via text to speech modality in processor 44.

Further, action block 360 may include, at action block 364, providing directional haptic alerts to the driver of the vehicle 10 via processor 44 through haptic feedback device 70. For example, the haptic feedback device 70 may provide an alert to the side of the driver on which the source of the sound is located.

Method 300 may continue at inquiry block 370, with determining, via processor 44, whether the array of sensors still detects the defined sound. When the processor 44 determines that the defined sound is still detected, then the alerts are still provided at action block 360. When the processor 44 determines that the defined sound is not detected, then method 300 continues at action block 380 with discontinuing any alert provided at action block 360. Then, the method 300 continues monitoring sound outside the vehicle at action block 310.

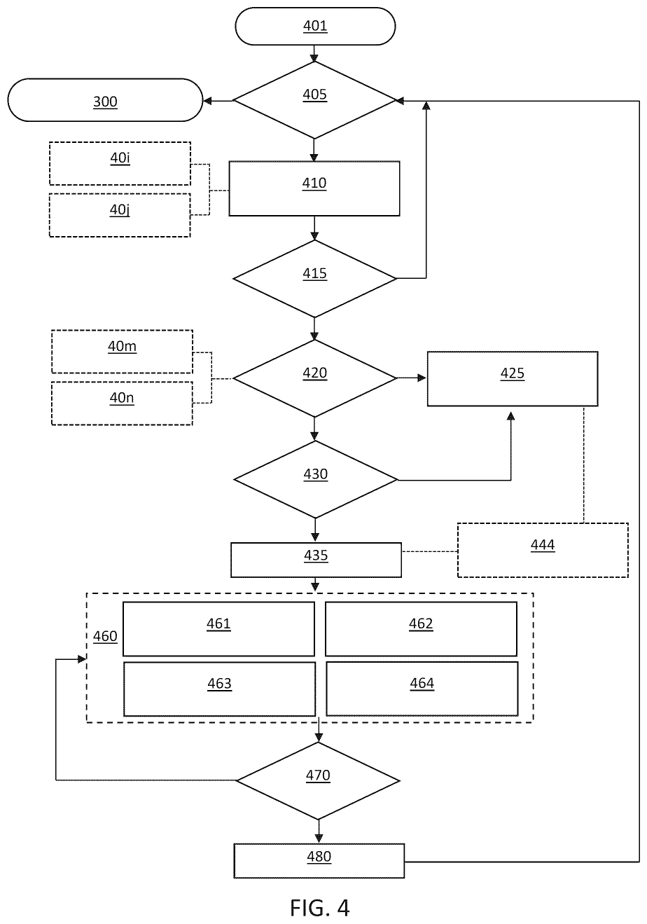

FIG. 4 is a flow chart illustrating a method 400 for operating the vehicle 10. The method is carried out by processor 44 of the system 1 of FIGS. 1 and 2.

As shown in FIG. 4, the method 400 begins with the vehicle propulsion system being actuated “ON” at action block 401.

At inquiry block 405, method 400 determines whether the vehicle 10 is located in an area of interest. For example, the processor 44 may access the defined maps of the navigable environment stored in the data storage device 32 and determine that the vehicle 10 is located near a child's playground, school, park or other programmed location. When the vehicle 10 is not located in an area of interest, method 400 may proceed at the normal operation of method 300.

When the vehicle 10 is in an area of interest, method 400 continues at action block 410, with monitoring sound outside the vehicle 10, such as with audio sensor arrays 40a-40n. For example, the array of sensors may include an exterior microphones 40m and interior microphones 40n.

At inquiry block 415, the method 400 determines, via processor 44, whether the array of sensors detects a sound. In method 400, the processor 44 may limit or focus on sounds typical of a child or children playing, for example a pitch range of children's voices.

When no sound is detected, then method 400 continues monitoring at inquiry block 405. When a sound is detected, then method 400 continues at action block 420 with determining whether the sound is an emergency siren. For example, the processor 44 may define the sound by decibel level. Further, the processor 44 may determine the front or rear direction and left or right direction, and distance of the source of the sound. As shown, the processor 44 may use signal inputs from exterior microphones 40m and interior microphones 40 n.

When the processor 44 determines that the sound is not an emergency siren, then at action block 425, method 400 may include communicating a vocalization prompt using prompt engineering, such as enabled by a large language model 444 contained in or accessible by the processor 44. For example, the processor 44 may communicate, through the vehicle audio system 80, a message indicating the presence of the source of the sound, the type of the source of the sound, and/or the location of the source of the sound, such as “Please be careful, children playing in the proximity of the vehicle”, “Please be careful, children playing behind the vehicle”, “Please be careful, children playing ninety feet in front of the vehicle on the right”, or something similar.

When the processor 44 determines that the sound is an emergency siren, then at inquiry block 430, method 400 determines whether the source of the sound is located at a location that is shielded from the vehicle 10. For example, the processor 44 may determine that the sound source is located on an overpass, i.e., on a different roadway, or determine that the sound source is on the same roadway but is on the opposite side of a hard median, i.e., a divided highway.

When the source of the sound is shielded from the sound source, then method 400 may continue at action block 425 with communicating a vocalization prompt using prompt engineering, such as enable by a large language model 444 contained in or accessible by the processor 44. For example, the processor 44 may communicate, through the vehicle audio system 80, a message indicating the presence of the source of the emergency siren, and/or the location of the source of the sound, such as “Emergency siren not located in lanes ahead, please proceed carefully.

When the source of the sound is not shielded from the sound source, then method 400 may continue at action block 435 with communicating a vocalization prompt using prompt engineering, such as enable by a large language model 444 contained in or accessible by the processor 44. For example, the processor 44 may communicate, through the vehicle audio system 80, a message indicating the presence of the source of the emergency siren, and/or the location of the source of the sound, such as “Please pull over to make way for emergency vehicle”, or something similar.

In addition, method 400 may continue at action block 460. For example, method 400 may include, at action block 461, communicating, via the processor 44, an alert lamp or graphic on the head-up display 60. For example, the alert lamp or graphic may be located on the left or right side of the head-up display 60 corresponding to the left or right side determined at action block 420.

Also, action block 460 may include, at action block 442, ducking the vehicle audio via processor 44, i.e., lowering the volume of the current audio output such as from speakers within the vehicle and amplifying external sound artifacts, and, at action block 463, providing navigational or safety instructions to the driver via text to speech modality in processor 44.

Further, action block 460 may include, at action block 464, providing directional haptic alerts to the driver of the vehicle 10 via processor 44 through haptic feedback device 70. For example, the haptic feedback device 70 may provide an alert to the side of the driver on which the source of the sound is located.

Method 400 may continue at inquiry block 470, with determining, via processor 44, whether the array of sensors still detects the defined sound. When the defined sound is still detected, then the alerts are still provided at action block 460. When the defined sound is not detected, then method 400 continues at action block 480 with discontinuing any alert provided at action block 460. Then, the method 400 continues at inquiry block 405.

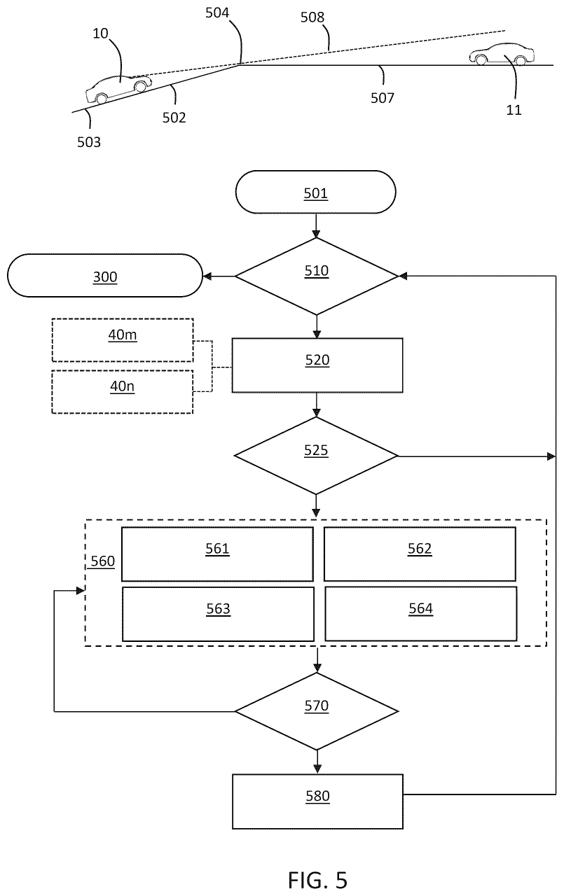

FIG. 5 is a schematic and flow chart illustrating a method 500 for operating the vehicle 10. The method is carried out by processor 44 of the system 1 of FIGS. 1 and 2. As shown in the schematic, method 500 may be followed in conditions in which an obstruction 504, such as a ridge 504 in the roadway 502, blocks the direct line of vision 508 of a driver of the vehicle 10 or of camera mounted to the vehicle 10. In the schematic, the vehicle 10 is on a first portion 503 of the roadway 502 and an object 11, such as a second vehicle, an emergency vehicle, a pedestrian, etc., is on a second portion 507 of the roadway 502. As shown, the ridge 504 limits the direct line of vision or sight 508 such that the object 11 cannot be seen by the driver or a camera of the vehicle 10. While first portion 503 of the roadway is illustrated as being uphill and the second portion 507 is illustrated as being level, embodiments are not so limited. Further, embodiments may include obstructions such as buildings which block vision in the lateral direction rather than the vertical direction.

As shown in FIG. 5, the method 500 begins with the vehicle propulsion system being actuated “ON” at action block 501.

At inquiry block 510, method 500 determines whether the vehicle 10 the line of sight 508 from vehicle 10 is obstructed, i.e., whether vision is lost in a blind zone. For example, in some embodiments, the processor 44 may determine that the vehicle 10 is traveling uphill, thus the eventual crest of the hill will obstruct vision. Other embodiment may use map coordinate data or sensing, such as from cameras.

When inquiry block 510 determines that the line of sight 508 is not obstructed, normal operation according to method 300 may be followed. When inquiry block 510 determines that the line of sight 508 is obstructed, then method 500 may continue at action block 520, with monitoring sound outside the vehicle 10, such as with audio sensor arrays 40a-40n. For example, the array of sensors may include an exterior microphones 40m and interior microphones 40n.

Method 500 continues at inquiry block 525, where the method 500 determines, via processor 44, whether the array of sensors detects a sound. When no sound is detected, then method 500 continues at inquiry block 510. When a sound is detected, then method 500 continues at action block 560. For example, method 500 may include, at action block 561, communicating, via the processor 44, an alert lamp or graphic on the head-up display 60. For example, the alert lamp or graphic may be located on the left or right side of the head-up display 60 corresponding to the left or right side determined at action block 520.

Also, action block 560 may include, at action block 542, ducking the vehicle audio via processor 44, i.e., lowering the volume of the current audio output such as from speakers within the vehicle and amplifying external sound artifacts, and, at action block 563, providing navigational or safety instructions to the driver via text to speech modality in processor 44.

Further, action block 560 may include, at action block 564, providing directional haptic alerts to the driver of the vehicle 10 via processor 44 through haptic feedback device 70. For example, the haptic feedback device 70 may provide an alert to the side of the driver on which the source of the sound is located.

Method 500 may continue at inquiry block 570, with determining, via processor 44, whether the array of sensors still detects the defined sound. When the defined sound is still detected, then the alerts are still provided at action block 560. When the defined sound is not detected, then method 500 continues at action block 580 with discontinuing any alert provided at action block 560. Then, the method 500 continues at inquiry block 510.

As described herein, embodiments may provide a sound visualization in a head-up display (HUD) for a vehicle. Such embodiments may detect external noises such as children, emergency vehicles, human presence through speech, i.e., people talking, car horns, animal sounds, i.e., external pet detection (e.g., a dog bark), motorcycle riders in a blind spot, etc., through an engine room microphone and a rear microphone. In such embodiments, the processor is configured to determine the type of noise that is detected, i.e., identify that the noise is from children, emergency vehicles, people talking, car horns, animal sounds, motorcycle riders, etc. In such embodiments, the exterior microphones are the primary source of sound capture. Interior microphones are used in conjunction with the exterior microphones to identify the location of the source of the sound. Amplification may be used to provide an overall processed audio buffer to assist in Deep Neural Network based classification of sound artifacts via the processor. Thus, the processor may identify a sound source as an emergency vehicle or law enforcement, as children playing, as diagnostic sounds (e.g., fuel pump, brake pads, suspension health, as a pet or other animal.

After processing the sound input and identifying the sound source identity and location, the system includes a post processing step of providing a multi-modal notification to the driver. Specifically, a visual notification may be displayed on the head-up display including text describing the sound source identity and location, as well as navigational or other driving instructions to mitigate or avoid risk. Likewise, an auditory notification may be communicated via speaker describing the sound source identity and location, as well as navigational or other driving instructions to mitigate or avoid risk.

In certain embodiments, from the detected external noise, the location information such as left/right/front/rear of the noise from the microphone inside the vehicle is synthesized and compared and judged through the amp.

In certain embodiments, the type/identity and location of the identified noise are displayed on the head up display with an alert sound. These notifications may be communicated in conjunction with directional haptic alerts through the seat and/or steering wheel.

In certain embodiments, the notification to the driver will use the auditory channel via text-to-speech-based feedback using a large language model. Upon classification, the system shall generate the vocalization prompt through the speakers.

Certain embodiments further include, after processing the sound input and identifying the sound source identity and location, ducking the current audio in the vehicle cabin so that external sound artifacts are audible to the driver and the occupants in the vehicle cabin. For example, broadcast and streaming music will be ducked to min audio levels. Further, the sound artifact upon classification may be mapped to a visual icon. In certain embodiments, a glossary of visual icons is stored in the memory and assigned to identified sounds. In certain embodiments, a third notification uses the auditory channel.

Certain embodiments use text-to-speech-based feedback using large language model included in the processor or system. Upon classification, the system generates a dynamic prompt. For example, the system may generate a prompt such as “Children detected playing in the proximity of your vehicle. Please take extra caution while driving. Kindly reduce the speed to 10 mph”, or “Emergency vehicle behind you, kindly pull over to the shoulder to make room.”

In certain embodiments, the system and method may identify a user or driver with a disability in the vehicle. For example, the system may detect that a hearing device is located in the vehicle and, if detected, can connect the hearing device via Bluetooth to the Infotainment Head Unit (IHU). Thus, the audio output levels shall be appropriately projected to the hearing devices.

In certain embodiments, the system may identify a distracted driver in the vehicle cabin. A driver monitoring system (DMS) can gauge distraction besides loud music sensed at in-vehicle interior microphone. When a distracted driver is identified, the system may duck the audio and alert the driver by audio alerts such as beeps and chimes or by haptic alerts.

In certain embodiments, all visual or audio notifications may be performed in conjunction with directional haptic alerts. In certain embodiments, the audio alerts may be emitted by a dedicated special audio source.

In certain embodiments, the system and method described herein provide situational context in terms of navigation scenario. Specifically, a hard median of a divided roadway may be identified, or an overpass or underpass, or a surface street. As a result, proper mitigation strategies may be communicated to the driver.

While not limiting, the following scenarios may be commonly encountered and resolved using the system and method described herein. For example, when an emergency vehicle is located on the opposite of the roadway from the vehicle and separated from the vehicle by a physical barrier such as a median, wall or fence, i.e., the roadway is a divided roadway, methods and systems herein may identify the location of the source of the emergency vehicle and provide an instruction to the driver that the present course of the vehicle need not be changed, and speed need not be slowed, as the emergency vehicle is separated from the vehicle. In another scenario, the emergency vehicle is on a different roadway, such as on an overpass, underpass, or adjacent non-connecting roadway. In such a scenario, methods and systems herein may identify the location of the source of the emergency vehicle and provide an instruction to the driver that the present course of the vehicle need not be changed, and speed need not be slowed, as the emergency vehicle is not on the same roadway as the vehicle. In another scenario, an emergency vehicle emitting an emergency siren may be located in a blind zone of the vehicle. In such an embodiment, methods and systems may duck the audio channel, amplify the external sound, provide an alert in the form of haptic feedback on the pertinent side of the vehicle, provide an alert in the form of a visual alert on the head-up display on the pertinent side of the vehicle, provide an alert in the form of an audio alert on the pertinent side of the vehicle, and/or provide textual instructions in visual and/or audio form that describe where the source of the emergency siren is located. Further, outside the blind zone of a camera or driver, methods and systems may detect pedestrians in the background by using microphones and may duck the audio channel, amplify the external sound, provide an alert in the form of haptic feedback on the pertinent side of the vehicle, provide an alert in the form of a visual alert on the head-up display on the pertinent side of the vehicle, provide an alert in the form of an audio alert on the pertinent side of the vehicle, and/or provide textual instructions in visual and/or audio form that describe where the source of the audio is located.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes may be made in the function and arrangement of elements without departing from the scope of the disclosure as set forth in the appended claims and the legal equivalents thereof.

What is claimed is:

1. A vehicle comprising:
a graphic projection display;
exterior microphones mounted to the vehicle; and
a processing device programmed to:
receive audio signals from the exterior microphones;
retrieve map data in a region around the vehicle;
identify from the audio signals a sound of interest;
identify a location of a source of the sound of interest;
determine a stationary status or a moving status of the source;
if the source has the moving status, determining a direction and speed of movement of the source;
ascertain from the map data and from the location, stationary status, moving status, direction, and/or speed, a preferred driving maneuver;
determine a graphic exemplifying the preferred driving maneuver; and
display the graphic upon the graphic projection display.

2. The vehicle of claim 1, wherein the graphic projection display comprises a substantially transparent windscreen head-up display comprising one of light emitting particles and microstructures over a predefined region of the windscreen permitting luminescent display while permitting vision therethrough.

3. The vehicle of claim 1, further comprising a haptic device, wherein the processing device is programmed to activate the haptic device to provide a haptic alert to a user of the source of the sound of interest.

4. The vehicle of claim 1, further comprising an audio device, wherein the processing device is programmed to:
duck a current audio output from the audio device; and
activate the audio device to provide an audio alert to a user of the source of the sound of interest.

5. The vehicle of claim 4, wherein the audio alert comprises a vocalization of instructions of the preferred driving maneuver.

6. The vehicle of claim 1, wherein the exterior microphones include a front exterior microphone mounted at a front of the vehicle and a rear exterior microphone mounted at a rear of the vehicle, wherein the processing device is programmed to identify the location of a source of the sound of interest based on a decibel difference between audio signals received from the front exterior microphone and the rear exterior microphone.

7. The vehicle of claim 1, wherein the interior microphones include a front left interior microphone and a front right interior microphone mounted at a front of the vehicle and a rear left interior microphone and a rear right interior microphone mounted at a rear of the vehicle, wherein the processing device is programmed to identify the location of a source of the sound of interest based on a decibel difference between audio signals received from the front interior microphones and the rear interior microphones.

8. The vehicle of claim 1, further comprising interior microphones located inside the vehicle, wherein the processing device is programmed to receive interior audio signals from the interior microphones.

9. A method comprising:
operating a vehicle;
retrieving, with a processor, map data in a region around the vehicle;
receiving an audio signal, with the processor, from an exterior microphone mounted at an exterior location of the vehicle;
processing, with a processor, the audio signal to determine a location of a source of the audio signal, to optionally determine whether the source is moving, and, if so, to determine a direction and speed of movement of the source;
ascertaining from the map data and from the location, direction, and/or speed, a preferred driving maneuver; and
actuating an alert device, with the processor, to communicate an alert to a driver of the vehicle regarding the preferred driving maneuver.

10. The method of claim 9, wherein ascertaining from the map data and from the location, direction, and/or speed, the preferred driving maneuver comprises identifying that the location is in an oncoming lane separated from the vehicle by a hard median.

11. The method of claim 9, further comprising determining, via the processor, whether the audio signal comprises an emergency siren.

12. The method of claim 9, further comprising ducking a current audio output, wherein communicating the alert to the driver comprises communicating an audio alert.

13. The method of claim 12, further comprising using a large language model to create the audio alert in the form of a vocalized speech.

14. The method of claim 9, wherein communicating the alert to the driver comprises communicating a haptic alert.

15. The method of claim 9, wherein communicating the alert to the driver comprises displaying a visual alert as a graphic exemplifying the preferred driving maneuver.

16. A method comprising:
operating a vehicle along a path;
determining, with a processor, that the vehicle is moving up a hill;
determining, with the processor, that visual perception of the path is blocked by a crest of the hill;
detecting sound from the path blocked by the crest of the hill with a microphone mounted on the vehicle;
receiving an audio signal, with the processor, from the microphone;
processing, with the processor, the audio signal to determine a location of a source of the audio signal, to determine that the source is moving, and, if so, to determine a direction and speed of movement of the source;
ascertaining from map data and from the location, direction, and/or speed, a preferred driving maneuver; and
actuating an alert device, with the processor, to communicate an alert to a driver of the vehicle regarding the preferred driving maneuver.

17. The method of claim 16, further comprising ducking a current audio output, wherein communicating the alert to the driver comprises communicating an audio alert.

18. The method of claim 17, further comprising using a large language model to create the audio alert in the form of a vocalized speech.

19. The method of claim 16, wherein communicating the alert to the driver comprises communicating a haptic alert.

20. The method of claim 16, wherein communicating the alert to the driver comprises displaying a visual alert as a graphic exemplifying the preferred driving maneuver.
